(19) United States
(12) Patent Application Publication
(10) Pub. No.: US 2018/0138848 A1
(43) Pub. Date: May 17, 2018

(54) MOTOR AND MOTOR DRIVING CIRCUIT

(71) Applicant: Johnson Electric S.A., Murten (CH)

(72) Inventors: Chiping SUN, Hong Kong (CN); Xiuwen YANG, Shenzhen (CN); Shinghin YEUNG, Hong Kong (CN); Shujuan HUANG, Shenzhen (CN); Yunlong JIANG, Shenzhen (CN)

(21) Appl. No.: 15/812,224

(22) Filed: Nov. 14, 2017

(30) Foreign Application Priority Data
Nov. 15, 2016 (CN) 2016 1102 6877.3
Nov. 15, 2016 (CN) 2016 1103 6649.4

(51) Int. Cl. H02P 23/24; H02M 7/06; H02P 6/30; H02P 25/022; G01D 5/14

(52) U.S. Cl. CPC H02P 23/24; H02M 7/06; G01D 5/142; H02P 25/022; H02P 6/30

(57) ABSTRACT

A motor driving circuit for driving a rotor of a motor to rotate with respect to a stator is disclosed. The motor driving circuit includes a controllable bidirectional alternating current (AC) switch, first and second detection circuits, a rotation direction control circuit, and a switch control circuit. The first and second detection circuits detect positions of magnetic poles of the rotor, and output magnetic pole position signals having opposite phases when detecting a same magnetic pole of the rotor. The rotation direction control circuit is configured to selectively output the magnetic pole position signal from the first or the second detection circuits to the switch control circuit according to a rotation direction setting signal of the motor. The switch control circuit is configured to control the controllable bidirectional AC switch to be switched between a switch-on state and a switch-off state to control the motor to rotate in two directions.

### CROSS REFERENCE TO RELATED APPLICATIONS

This non-provisional patent application claims priority under 35 U. S. C. § 119(a) from Patent Application No. 201611026877.3 filed in the People's Republic of China on Nov. 15, 2016, and Patent Application No. 201611036649.4 filed in the People's Republic of China on Nov. 15, 2016, the entire contents of which are hereby incorporated by reference.

### FIELD OF THE INVENTION

The present disclosure relates to the field of motor control, and in particular to a motor and a motor driving circuit.

### BACKGROUND OF THE INVENTION

Motor are electromagnetic devices that convert or transmit electrical energy into mechanical energy according to the law of electromagnetic induction. The main role of the motor is to produce a rotational torque as a power source for electrical appliances or various machines. Single-phase permanent magnet motors are widely used in various electrical products for its simple operation and easy control. But the current bi-directional control circuit of motor has a complex structure.

### SUMMARY

In view of the above, there is a desire for a motor driving circuit which can drive the motor in both directions having a simple structure and convenient operation, and a motor including the same.

According to one aspect, a motor driving circuit for driving a rotor of a motor to rotate with respect to a stator is provided. The motor driving circuit includes:

a controllable bidirectional alternating current (AC) switch, connected with a winding of the motor between two terminals of an AC power supply;

a first detection circuit and a second detection circuit, respectively configured to detect positions of magnetic poles of the rotor, and output magnetic pole position signals having opposite phases when detecting a same magnetic pole of the rotor;

a rotation direction control circuit connected to the first and second detection circuits, and configured to selectively output the magnetic pole position signals from the first detection circuit or the second detection circuit to a switch control circuit according to a rotation direction setting signal of the motor;

wherein the switch control circuit is configured to control the controllable bidirectional AC switch to be switched between a switch-on state and a switch-off state to control the motor to rotate in a predetermined direction or in a direction opposite to the predetermined direction, based on the received magnetic pole position signal and a polarity of the AC power supply.

Preferably, the switch control circuit is configured to control the controllable bidirectional AC switch to be switched to the switch-on state when the polarity of the AC power supply is in a positive half-cycle and the rotation direction control circuit outputs a first signal, or the switch control circuit is configured to control the controllable bidirectional AC switch to be switched to the switch-on state when the polarity of the AC power supply is in a negative half-cycle and the rotation direction control circuit outputs a second signal.

Preferably, the rotation direction control circuit outputs the magnetic pole position signal from the first detection circuit to the switch control circuit when the motor rotates in the predetermined direction; and the rotation direction control circuit outputs the magnetic pole position signal from the second detection circuit to the switch control circuit when the motor rotates in the direction opposite to the predetermined direction.

Preferably, the first detection circuit includes a first Hall sensor, the second detection circuit includes a second Hall sensor, and a direction in which a first Hall plate in the first Hall sensor faces the rotor is inverted by 180 degrees with respect to the direction in which a second Hall plate in the second Hall sensor faces the rotor.

Preferably, at a rest position of the motor, the first Hall sensor and the second Hall sensor are both disposed adjacent to a north pole of the rotor, or the first Hall sensor is adjacent to a north pole of the rotor and the second Hall sensor is adjacent to a south pole of the rotor.

Preferably, the rotation direction control circuit includes a switch unit, the switch unit includes first to third terminals, the first terminal is connected to the switch control circuit, the second terminal receives the magnetic pole position signal from the first detection circuit, the third terminal receives the magnetic pole position signal from the second detection circuit, and the first terminal is selectively connected to the second terminal or the third terminal according to the rotation direction setting signal of the motor; when the first terminal is connected to the second terminal, the motor rotates in the predetermined direction; and when the first terminal is connected to the third terminal, the motor rotates in the direction opposite to the predetermined direction.

Preferably, the switch unit of the rotation direction control circuit further includes a fourth terminal, the fourth terminal is null, when switching the rotation direction of the motor during rotation, the first terminal is connected to the fourth terminal for a preset time to stop the rotor at a predetermined rest position, then the first terminal is connected to the terminal corresponding to the switching direction.

Preferably, the motor driving circuit further includes a rectifier for providing a DC voltage to at least the first and the second Hall sensors, the rectifier includes first and second output terminals, a voltage output from the first output terminal is higher than that from the second output terminal, power supply terminals of the first and second Hall sensors are connected to the first output terminal, and ground terminals of the first and second Hall sensors are connected to the second output terminal.

Preferably, the motor driving circuit further includes a voltage reducer connected to the rectifier, for stepping down an AC voltage from the AC power supply and then inputting the reduced voltage to the rectifier, the switch control circuit includes a first resistor, an NPN transistor, a second resistor, and a diode; the second resistor and diode are connected in series between the rotation direction control circuit and the controllable bidirectional AC switch; a cathode of the diode is connected to the rotation direction control circuit; an end of the first resistor is connected to a first output terminal of the rectifier, and the other end of the first resistor is connected to the cathode of the diode; a base of the NPN transistor is connected to the cathode of the diode, an emitter of the NPN transistor is connected to an anode of the diode, and a collector of the NPN transistor is connected to the first output terminal of the rectifier.

Preferably, the motor driving circuit further includes a control switch, the control switch is connected between the AC power supply and the winding of the motor, when changing the rotation direction the during the rotation of the motor, the control switch is turned off for a predetermined time until the rotor stops at a predetermined rest position.

In another aspect, a motor driving circuit for rotating a rotor of a motor with respect to a stator is provided. The motor driving circuit includes:

a controllable bidirectional AC switch, connected between a first node and a second node, a motor winding and an AC power supply connected in series between the first node and the second node, or the controllable bidirectional AC switch and the motor winding connected in series between the first node and the second node, and the AC power supply connected between the first node and the second node;

first and second motor driving integrated circuits having the same structure, each of which including a housing, the housing including a front wall and a rear wall, the front wall of the first motor driving integrated circuit facing the rotor, the rear wall of the second motor driving integrated circuit facing the rotor, each of the first and second motor driving integrated circuits including:

a detection circuit, configured for detecting a magnetic pole position of the rotor and outputting a magnetic pole position signal at an output thereof;

a switch control circuit, configured to output a control signal according to the magnetic pole position signal from the detection circuit and a polarity of the AC power supply;

a rotation direction control circuit, configured to selectively output the control signal from the first or second motor drive integrated circuits to the controllable bidirectional AC switch according to the rotation direction setting signal of the motor to control on and off states of the controllable bidirectional AC switch to rotate the motor in a predetermined direction or in a direction opposite to the predetermined direction.

In still another aspect, a motor including a stator, a rotor and a motor driving circuit described above is provided.

Preferably, the motor is a single-phase permanent magnet AC motor, a single-phase permanent magnet synchronous motor, or a single-phase permanent magnet BLDC motor.

The motor driving circuit according to the embodiments of the present disclosure detects the magnetic pole position of the rotor by the two detection circuits or the two motor drive integrated circuits, and when the two detection circuits or the two motor drive integrated circuits detect the same magnetic pole of the rotor, the magnetic pole position signals having opposite phases are output therefrom. The rotation direction control circuit selectively outputs the magnetic pole position signal or the control signal to control the state of the controllable bidirectional AC switch according to the rotation direction setting signal of the motor, and then control the current direction flowing the motor stator winding to control the clockwise and counterclockwise rotation of the motor. The motor driving circuit has a simple structure and a great universality.

### BRIEF DESCRIPTION OF THE DRAWINGS

FIG. 1 is a schematic diagram of a motor according to a first embodiment of the present disclosure.

FIG. 2 is a schematic diagram of an embodiment showing the relative position between a first Hall sensor, a second Hall and the rotor of FIG. 1.

FIG. 3 is a schematic diagram of another embodiment showing the relative position between a first Hall sensor, a second Hall and the rotor of FIG. 1.

FIG. 4 is a circuit diagram showing the operation principle of the Hall sensor.

FIG. 5 is a circuit diagram of an embodiment of a rotation direction control circuit.

FIG. 6 is a circuit diagram of a motor according to a second embodiment of the present disclosure.

FIG. 7 is a circuit diagram of a motor according to a third embodiment of the present disclosure.

FIG. 8 is a circuit diagram of a motor according to a fourth embodiment of the present disclosure.

FIG. 9 is a circuit diagram of a motor according to a fifth embodiment of the present disclosure.

### DETAILED DESCRIPTION OF THE PREFERRED EMBODIMENTS

The subject matter will be described in conjunction with the accompanying drawings and the preferred embodiments. The described embodiments are only a few and not all of the embodiments of the present disclosure. All other embodiments obtained by those ordinarily skilled in the art based on the embodiments of the present disclosure without any creative efforts fall within the protection scope of the present disclosure. It is to be understood that, the drawings are provided for reference only and are not intended to be limiting of the invention. In the drawings, a displayed connection is merely for clear description, not to limit a connection manner.

It should be noted that when a component is considered to be “connected” to another component, it can be directly connected to another component or may also have a centered component. Unless otherwise defined, all technical and scientific terms used herein have the same meaning as commonly understood by those ordinarily skilled in the art. The terminology used in the specification of the present disclosure is only for the purpose of describing particular embodiments and is not intended to limit the invention.

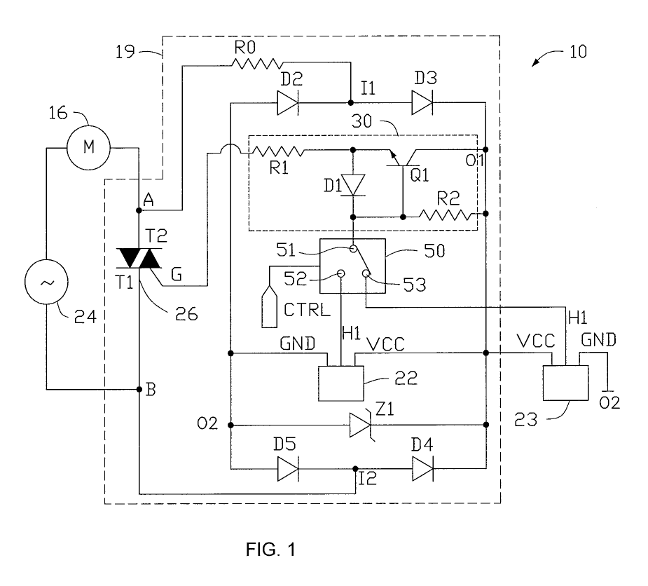

FIG. 1 illustrates a circuit diagrams of a motor 10 according to a first embodiment of the present disclosure, and the motor 10 can rotate in both directions i.e. clockwise and counterclockwise direction. The motor 10 includes a stator and a rotor 11 rotatable relative to the stator. The stator includes a stator core and a stator winding 16 wound around the stator core. The stator core can be made of soft magnetic materials such as pure iron, cast iron, cast steel, electrical steel, silicon steel, and ferrite. The rotor 11 is a permanent magnet rotor, when the stator winding 16 is connected to an alternating current (AC) power supply 24, the rotor 11 operates at a constant rotational speed of 60 f/p revolutions per minute during a steady state operation of the motor, wherein f is a frequency of the AC power supply, and p is the number of pole pairs of the rotor. In this embodiment, the stator core includes two opposite pole shoes (not shown). Each pole shoe has a pole arc surface, an outer surface of the rotor is opposite to the pole arc surface, and a substantially uniform air gap is formed therebetween. In the present disclosure, the substantially uniform air gap means that a uniform air gap is formed in most space between the stator and the rotor, and a non-uniform air gap is formed only in a small portion of the space between the stator and the rotor. Preferably, the pole arc surface of the pole shoes is provided with a concave starting groove, and the other portion of the pole arc surface except the starting groove is concentric with the rotor 11. The above configuration may form an uneven magnetic field which allows the motor 10 to have a starting torque every time the motor 10 is energized by a motor driving circuit 19. In this embodiment, the stator and the rotor 11 each has two magnetic poles. It can be understood that, in other embodiments, the number of the magnetic poles of the stator may not be equal to that of the rotor, and the stator and the rotor may have more magnetic poles, such as four, six.

The stator winding 16 and the motor driving circuit 19 are connected in series between two ends of the AC power supply 24. The motor driving circuit 19 can control the clockwise and counterclockwise rotation of the motor 10. The AC power supply 24 may be a commercial AC power supply, for example, 220V, 230V, or an AC power supply output from an inverter.

The motor driving circuit 19 includes a first detection circuit, a second detection circuit, a rectifier, a controllable bidirectional AC switch 26, a switching control circuit 30, and a rotation direction control circuit 50. The controllable bidirectional AC switch 26 is connected between a first node A and a second node B, and the stator winding 16 is connected in series with the AC power supply 24 between the first node A and the second node B. A first input terminal I1 of the rectifier is connected to the first node A through a resistor R0, and the second input terminal I2 of the rectifier is connected to the second node B. The rectifier is configured for converting the AC power supply into direct current and supplying the direct current to the first detection circuit and the second detection circuit.

In other embodiments, the stator winding 16 is connected in series with the controllable bidirectional AC switch 26 between the first node A and the second node B, and the AC power supply 24 is connected between the first node A and the second node B.

The first detection circuit and the second detection circuit respectively detect the magnetic pole positions of the rotor 11 through detecting a strength of a magnetic field of the magnetic poles of the rotor, and output corresponding magnetic pole position signals, for example, 5V or 0V, at their output terminals. The first detection circuit and the second detection circuit are preferably Hall sensors, such as linear Hall sensors or switch type Hall sensors, which are denoted as a first Hall sensor 22 and a second Hall sensor 23 respectively in this embodiments. It can be understood that, in other embodiments, the first and second detection circuits may also be photoelectric encoders. The first Hall sensor 22 and the second Hall sensor 23 each includes a power supply terminal VCC, a ground terminal GND, and an output terminal H1. In this embodiment, the first Hall sensor 22 and the second Hall sensor 23 output the magnetic pole position signals having opposite phases when sensing the magnetic pole of the rotor 11 having the same polarity.

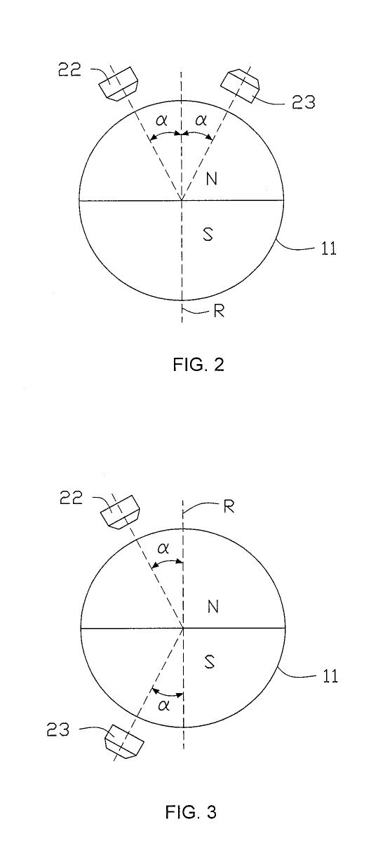

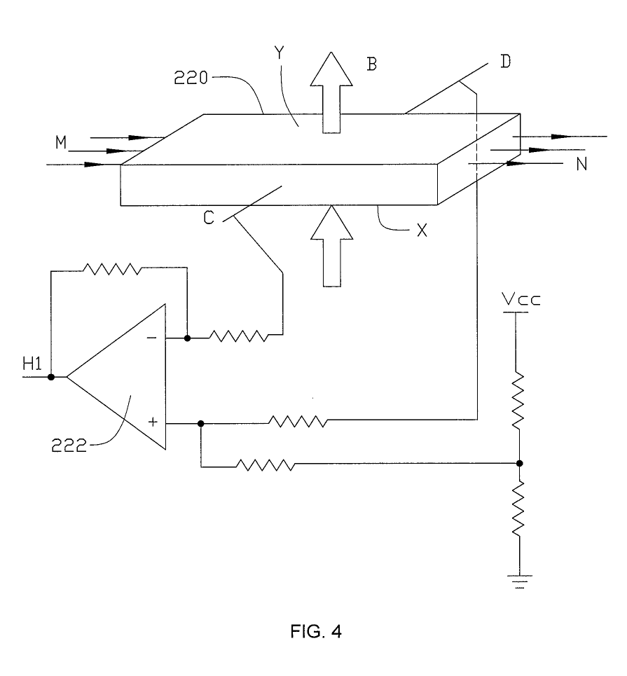

The first Hall sensor 22 and the second Hall sensor 23 have the same structure, and are both integrated circuits having a housing. The housing includes a front wall and a rear wall. A semiconductor sheet (such as Hall plate 220) and a signal amplifier 222 are accommodated in the housing (see FIG. 4). When the first Hall sensor 22 and the second Hall sensor 23 are mounted in the motor 10, the front wall of the first Hall sensor 22 faces the rotor 11, and the rear wall of the second Hall sensor 23 faces the rotor 11. At a rest position of the motor, the first Hall sensor 22 is arranged with a counterclockwise offset with respect to a pole axis R of the rotor 11 to form an angle; the second Hall sensor 23 is arranged with a clockwise offset with respect to the pole axis R of the rotor 11 to form an angle, and in this embodiment, the two angles are equal to each other and denoted as a. A virtual connection line crossing the centers of the two opposite magnetic poles (i.e., two magnets in the present embodiment) of the rotor 11 in a radial direction is denoted as the pole axis R of the rotor 11. In the embodiment as shown in FIG. 2, the first Hall sensor 22 and the second Hall sensor 23 are arranged adjacent to a same magnetic pole of the rotor 11, such as a north pole. In other embodiments, as shown in FIG. 3, the first Hall sensor 22 and the second Hall sensor 23 are arranged adjacent to different magnetic poles of the rotor 11, for example, the first Hall sensor 22 is arranged adjacent to a north pole of the rotor 11, and the second Hall sensor 23 is arranged adjacent to a south pole of the rotor 11. It can be understood that, the rotor 11 may include a plurality of pairs of magnetic poles, an electrical angle of the angle α is less than 90/N degrees, wherein N is the number of pairs of the magnetic poles of the rotor. In this embodiment, the angle α is in the range of being equal or greater than 0 degrees and less than 90/N degrees, that is, the angle α is equal to or greater than 0 degrees and less than 45 degrees. Preferably, the angle may be 0 degrees, 15 degrees, 20 degrees, 25 degrees, 30 degrees, 35 degrees, or 40 degrees. Preferably, at the predetermined rest position of the rotor, the first and second Hall sensors 22, 23 are arranged remote away from a zero-crossing region of the rotor magnetic field, i.e., the weakest magnetic field area of the rotor, so that the rotor can be successfully started.

The rotation direction control circuit 50 is connected to the first Hall sensor 22 and the second Hall sensor 23, and is configured to selectively output the magnetic pole position signal from the first Hall sensor 22 or the second Hall sensor 23 to the switching control circuit 30 according to a rotation direction setting signal of the motor. The switch control circuit 30 controls the controllable bidirectional AC switch 26 to be switched between on and off states in a predetermined manner, according to the received magnetic pole position signal and a polarity information of the AC power supply 24, to control the motor to rotate in clockwise or counterclockwise direction.

The rectifier includes four diodes D2-D5. A cathode of the diode D2 is connected to an anode of the diode D3, a cathode of the diode D3 is connected to a cathode of the diode D4, an anode of the diode D4 is connected to a cathode of the diode D5, and an anode of the diode D5 is connected to an anode of the diode D2. The cathode of the diode D2 acts as the first input terminal I1 of the rectifier and is connected to the first node A via a resistor R0. The resistor R0 may act as a voltage reducer. The anode of the diode D4 acts as a second input terminal I2 of the rectifier and is connected to the second node B. The cathode of the diode D3 acts as a first output terminal O1 of the rectifier, and is connected to the power supply terminals VCC of the first Hall sensor 22 and the second Hall sensor 23. The anode of the diode D5 acts as a second output terminal O2 of the rectifier and is connected to the ground terminal GND of the first Hall sensor 22 and the second Hall sensor 23. The first output terminal O1 outputs a high DC operating voltage, the second output terminal O2 outputs a low DC operating voltage which is lower than the voltage of the first output terminal O1. A Zener diode Z1 is connected between the first output terminal O1 and the second output terminal O2 of the rectifier, an anode of the Zener diode Z1 is connected to the second output terminal O2, and a cathode of the Zener diode Z1 is connected to the first output terminal O1.

In this embodiment, the output terminals H1 of the first Hall sensor 22 and the second Hall sensor 23 are connected to the rotation direction control circuit 50. When the first Hall sensor 22 is normally powered, that is, the power terminal VCC receives the high DC operating voltage and the ground terminal GND receives the low DC voltage, the output terminal H1 of the first Hall sensor 22 outputs the magnetic pole position signal with a high level if the detected magnetic field of the rotor is north, and outputs the magnetic pole position signal with a low level if the detected magnetic pole of the rotor is south. When the second Hall sensor 23 is normally powered, that is, the power terminal VCC receives a high DC operating voltage and the ground terminal GND receives a low DC operating voltage, the output terminal H1 of the second Hall sensor 23 outputs the magnetic pole position signal with a low level if the detected magnetic field of the rotor is north, and outputs the magnetic pole position signal with a high level if the detected magnetic pole of the rotor is south.

The principle that the first Hall sensor 22 and the second Hall sensor 23 outputting the magnetic pole position signals having the opposite phases when detecting the magnetic pole having a same polarity is described hereafter. Referring to FIG. 4, the Hall plate 220 includes a front wall X and a rear wall Y. When the Hall plate 220 is packaged into the housing of the Hall sensor, the front wall X corresponds to the front wall of the housing of the Hall sensor, the rear wall Y corresponds to the rear wall of the housing of the Hall sensor. The Hall plate 220 further includes two excitation current terminals M, N (respectively corresponding to the power terminal VCC and the ground terminal GND in FIG. 1) and two Hall electromotive force output terminals C, D. Two input terminals of the signal amplifier 222 are connected to the two Hall electromotive force output terminals C and D respectively. A case that the first and second Hall sensors 22 and 23 both sense north of the rotor will be described as an example. As the front wall of the first Hall sensor 22 faces the rotor 11, the Hall plate 220 of the first Hall sensor 22 is in a magnetic field with a magnetic induction intensity of B when the north magnetic field of the rotor 11 is detected. A direction of the magnetic field is perpendicular to the Hall plate 220 from bottom to top, as shown in FIG. 4, where the direction of the magnetic field points from the front wall X to the rear wall Y of the Hall plate 220. When a current from the excitation current terminal M to the excitation current terminal N flows through the Hall plate 220, electrons are deflected under Lorentz force and accumulated at the Hall electromotive force output terminal C, and there is a lack of electrons at the Hall electromotive force output terminal D. Therefore, the Hall electromotive force output terminal C is negatively charged while the Hall electromotive force output terminal D is positively charged, and a Hall electromotive force is generated in a direction perpendicular to the current and the magnetic field, i.e., between the Hall electromotive force output terminals C and D. The signal amplifier 222 amplifies the Hall electromotive force and generates the magnetic pole position signal in a form of a digital signal. In this case, the magnetic pole position signal is a logic high level “1” which is output from the output terminal H1 of the first Hall sensor.

As the rear wall of the second Hall sensor 23 faces the rotor 11, the Hall plate 220 of the second Hall sensor 23 is in a magnetic field with a magnetic induction intensity of B when the magnetic field of the rotor is sensed to be north. A direction of the magnetic field is downward and is perpendicular to the Hall plate 220. As the second Hall sensor 23 is reversed with respect to the first Hall sensor 22, the direction of the magnetic field points from the rear wall Y to the front wall X of the Hall plate 220 when viewed from the second Hall sensor 23, and a direction in which the magnetic field crosses the Hall plate 220 is opposite to the direction in FIG. 4. When a current flowing from the excitation current terminal M to the excitation current terminal N flows through the Hall plate 220, there are electrons accumulating at the Hall electromotive force output terminal D, and there is a lack of electrons at the Hall electromotive force output terminal C Therefore, the Hall electromotive force output terminal D is negatively charged while the Hall electromotive force output terminal C is positively charged, and a Hall electromotive force is generated in a direction perpendicular to the current and the magnetic field, i.e., between the Hall electromotive force output terminals C and D. The signal amplifier 222 amplifies the Hall electromotive force and generates the magnetic pole position signal in a form of a digital signal. In this case, the magnetic pole position signal is a logic low level “0” which is output from the output terminal H1 of the second Hall sensor.

When the first Hall sensor 22 and the second Hall sensor 23 sense the south pole of the rotor, the output terminal H1 of the first Hall sensor 22 outputs a logic low level, and the output terminal H1 of the second Hall sensor 23 outputs a logic high level, where the principle is similar to the above and will not be described in detail.

In summary, the first Hall sensor 22 is arranged in the motor with the front wall facing the rotor, and the second Hall sensor 23 is arranged in the motor with the rear wall facing the rotor, so that the direction in which the second Hall sensor 23 faces the rotor is reversed by 180 degrees with respect to the direction in which the Hall plate of the first Hall sensor 22 faces the rotor 11. The first Hall sensor 22 and the second Hall sensor 23 output the magnetic pole position signals having the opposite phases when sensing the magnetic pole with a same polarity.

Referring to FIG. 1 again, the rotation direction control circuit 50 includes a switch unit having first to third terminals 51-53. The first terminal 51 is connected to the switch control circuit 30, the second terminal 52 receives the magnetic pole position signal output from the first Hall sensor 22, and the third terminal 53 receives the magnetic pole position signal output from the second Hall sensor 23. The rotation direction control circuit 50 selectively connects the first terminal 51 to the second terminal 52 or the third terminal 53, according to a rotation direction setting signal CTRL.

The switch control circuit 30 includes first to third terminals, the first terminal is connected to the first output terminal O1 of the rectifier, the second terminal is connected to the first terminal 51 of the rotation direction control circuit 50, and the third terminal is connected to a control terminal G of the controllable bidirectional AC switch 26. The switch control circuit 30 further includes a resistor R2, an NPN transistor Q1, a diode D1, and a resistor R1. The diode D1 and resistor R1 are connected in series between the first terminal 51 of the rotation direction control circuit 50 and the controllable bidirectional AC switch 26. The cathode of the diode D1 acts as the second terminal of the switch control circuit 30 and is connected to the first terminal 51 of the rotation direction control circuit 50. One end of the resistor R2 is connected to the first output terminal O1 of the rectifier, and the other end of the resistor R2 is connected to the cathode of the diode D1. A base of the NPN transistor Q1 is connected to a cathode of the diode D1, an emitter of the NPN transistor Q1 is connected to an anode of the diode D1, and a collector of the NPN transistor Q1 acts as the first terminal of the switch control circuit 30 and is connected to the first output terminal O1 of the rectifier. The end of the resistor R1 which is not connected to the diode D1 acts as the third terminal of the switch control circuit 30.

The controllable bidirectional AC switch 26 is preferably a TRIAC, a first anode T1 of which is connected to the second node B, a second anode T2 of which is connected to the first node A, and the control terminal G of which is connected to the third terminal of the switch control circuit 30. It can be understood that, the controllable bidirectional AC switch 26 may be an electronic switch which allows currents to flow in two directions, and includes at least one component selected from the group consisting of metal oxide semiconductor field effect transistor (MOSFET), silicon controlled rectifier (SCR), TRIAC, insulated gate bipolar transistor, bipolar junction transistor (BJT), thyristor, and optocoupler. For example, two MOSFETs may form the controllable bidirectional AC switch; two SCRs may form the controllable bidirectional AC switch; two insulated gate bipolar transistors may form the controllable bidirectional AC switch; two BJTs can form the controllable bidirectional AC switch.

The switch control circuit 30 is configured to turn on the controllable bidirectional AC switch 26 when the AC power supply is in a positive half-cycle and the second terminal of the switch control circuit 30 receives the magnetic pole position signal with a first level, or when the AC power supply is in a negative half-cycle and the second terminal of the switch control circuit 30 receives the magnetic pole position signal with a second level. The switch control circuit 30 is configured to not turn on the controllable bidirectional AC switch 26 when the AC power supply is in a negative half-cycle and the second terminal of the switch control circuit 30 receives the magnetic pole position signal with a first level, or when the AC power supply is in a positive half-cycle and the second terminal of the switch control circuit 30 receives the magnetic pole position signal with a second level. Preferably, the first level is a logic high level, and the second level is a logic low level.

An operation principle of the motor driving circuit 19 controlling the motor to rotate in clockwise or counterclockwise direction is described hereinafter.

According to the electromagnetic theory, for a single-phase permanent magnet motor, the rotation direction of the rotor of the motor can be changed by changing conduction manner of the stator winding 16. If a polarity of the rotor sensed by a Hall sensor is north, and an AC power supply flowing through the stator winding 16 is in a positive half-cycle, the motor rotates in counterclockwise (CCW) direction, it can be understood that, if the polarity of the rotor sensed by the Hall sensor is still north, and the AC power supply flowing through the stator winding 16 is in a negative half-cycle, the rotor of the motor rotates in clockwise (CW) direction. The embodiments of the present disclosure is designed based on the principle that adjusting rotating direction of the rotor by changing the direction of the current flowing through the stator winding 16 based on the polarities of the rotor sensed by the first Hall sensor 22 and the second Hall sensor 23. In this embodiment, the first Hall sensor 22 and the second Hall sensor 23 output the magnetic pole position signals having the opposite phases when sensing the same magnetic pole of the rotor, and the switch control circuit 30 controls the polarity of the AC power supply flowing through the stator winding 16, based on the magnetic pole position signal, to control the rotation direction of the motor.

Table 1 is a function table of controlling clockwise or counterclockwise rotation of the motor based on the rotation direction setting signal CTRL.

TABLE 1

| rotation direction setting | selected detection | rotation direction of |
|---|---|---|
| signal CTRL | circuit | motor |
| 0 | first Hall sensor | counterclockwise |
| 1 | second Hall sensor | clockwise |

The clockwise direction of the motor is taken as an example for description hereinafter. It is assumed that the rotation direction setting signal CTRL is at a logic high level “1”, the first terminal 51 of the rotation direction control circuit 50 is connected to the third terminal 53, and the switch control circuit 30 receives the magnetic pole position signal output from the second Hall sensor 23. When the motor is powered on, if the second Hall sensor 23 senses that the magnetic field of the rotor is north, the second Hall sensor 23 outputs the magnetic pole position signal of the logic low level “0”, the cathode of the diode D1 of the switch control circuit 30 receives a low level signal, and the NPN transistor Q1 is turned off. If the AC power supply is in a negative half-cycle when the motor is powered on, the AC power supply in the negative half-cycle flows to the ground through the control terminal G of the controllable bidirectional AC switch 26, the resistor R1 and the diode D1 The controllable bidirectional AC switch 26 is turned on, and the rotor 11 starts to rotate clockwise. If the AC power supply is in a positive half-cycle when the motor is powered on, the AC power supply in the positive half-cycle cannot pass through the NPN triode Q1, no current flows through the control terminal G of the controllable bidirectional AC switch 26, the controllable bidirectional AC switch 26 is not turned on, and the rotor 11 does not rotate.

If the second Hall sensor 23 senses that the magnetic pole of the rotor is south, and outputs the magnetic pole position signal with the logic high level “1” to the switch control circuit 30, the cathode of the diode D1 in the switch control circuit 30 receives the high level, and the NPN transistor Q1 is turned on. Therefore, the anode of the diode D1 is at a high level. If the AC power supply is in a negative half-cycle when the motor is powered on, the AC power supply in the negative half-cycle cannot pass through the control terminal G of the controllable bidirectional AC switch 26 and the resistor R1, the controllable bidirectional AC switch 26 is not turned on, and the rotor 11 does not rotate. If the AC power supply is in a positive half-cycle when the motor is powered on, the AC power supply in the positive half-cycle flows through the NPN transistor Q1 and the resistor R1 to the control terminal G of the controllable bidirectional AC switch 26, the controllable bidirectional AC switch 26 is turned on, the positive half-cycle of the AC power supply flows through the stator winding, and the rotor 11 starts to rotate clockwise.

If the motor is to be controlled to rotate reversely, i.e., rotate counterclockwise, the rotation direction setting signal CTRL is change to a logic low level “0”, the first terminal 51 of the rotation direction control circuit 50 is connected to the second terminal 52, and the switch control circuit 30 receives the magnetic pole position signal output from the first Hall sensor 22. If the first Hall sensor 22 senses that the magnetic field of the rotor is north, and outputs the magnetic pole position signal with the logic high level “1”, and the NPN transistor Q1 is turned on. Therefore, the anode of the diode D1 is at a high level. If the AC power supply is in a negative half-cycle when the motor is powered on, the AC power supply in the negative half-cycle cannot pass the control terminal G of the controllable bidirectional AC switch 26 and the resistor R1, the controllable bidirectional AC switch 26 is not turned on, and the rotor 11 does not rotate. If the AC power supply is in a positive half-cycle when the motor is powered on, the AC power supply in the positive half-cycle flows through the NPN transistor Q1 and the resistor R1 to the control terminal G of the controllable bidirectional AC switch 26, the controllable bidirectional AC switch 26 is turned on, and the rotor 11 starts to rotate counterclockwise.

If the first Hall sensor 22 senses that the magnetic pole of the rotor is south, and outputs the magnetic pole position signal with the logic low level “0”, the cathode of the diode D1 of the switch control circuit 30 receives the logic low level, and the NPN transistor Q1 is turned off. If the AC power supply is in a negative half-cycle when the motor is powered on, the AC power supply in the negative half-cycle flows to the ground through the control terminal G of the controllable bidirectional AC switch 26, the resistor R1, and the diode D1. The controllable bidirectional AC switch 26 is turned on, the negative half-cycle of the AC power supply flows through the stator winding 16, and the rotor 11 starts to rotate counterclockwise. If the AC power supply is in a positive half-cycle when the motor is powered on, the AC power supply in the positive half-cycle cannot pass the NPN transistor Q1, no current flows through the control terminal G of the controllable bidirectional AC switch 26, the controllable bidirectional AC switch 26 is not turned on, and the rotor 11 does not rotate.

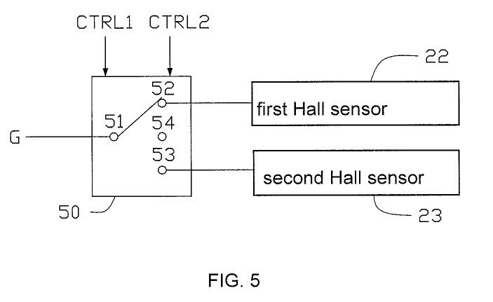

The situation that the rotor does not rotate described above happens when the motor is powered on. After the motor is started successfully, even if the controllable bidirectional AC switch 26 is not turned on, the rotor 11 will keep rotating under inertia. In addition, when changing the rotation direction of the rotor 11, it is necessary to stop the rotation of the rotor 11 of the motor first, to make the rotor 11 stop at a predetermined rest position. It is easy to stop the rotor 11 of the motor from rotating. For example, a switch (not shown) is added between the AC power supply 24 and the stator winding 16 of the motor, and the rotor 11 is stopped from rotating by turning off the switch for a predetermined time. There may be other implementations for stopping the rotor 11 of the motor from rotating, for example, referring to FIG. 5, the switch unit of the rotation direction control circuit 50 further includes a fourth terminal 54, the fourth terminal 54 is null, and a state of the rotation direction control circuit 50 is controlled by two rotation direction setting signals CTRL1 and CTRL2.

The following gives an embodiment to illustrate the process of changing the rotation direction of the motor. The rotation direction setting signals CTRL1=0 and CTRL2=0 is transmitted to the rotation direction control circuit 50 through an external controller by a user, the first terminal 51 of the rotation direction control circuit 50 is connected to the second terminal 52, the first Hall sensor 22 is selected to be connected to the switch control circuit 30, and the motor rotates counterclockwise. During the rotation of the motor, if the user wants to change the rotation direction of the motor, the rotation direction setting signals CTRL1=1 and CTRL2=1 may be output via the external controller, and the first terminal 51 of the rotation direction control circuit 50 is connected to the fourth terminal 54. As the fourth terminal 54 is null, there is no current flowing through the control terminal G of the controllable bidirectional AC switch 26, and the motor stops after rotating for a while under inertia. After a predetermined time, the external controller outputs the rotation direction setting signals CTRL1=1 and CTRL2=0 to the rotation direction control circuit 50, the first terminal 51 of the rotation direction control circuit 50 is connected to the third terminal 53, the second Hall sensor 23 is selected to be connected to the switch control circuit 30, and the motor rotates clockwise.

Table 2 shows situations of controlling clockwise or counterclockwise rotation of the motor based on the rotation direction setting signal of the motor, the position of the magnetic pole of the rotor, and the polarity of the AC power supply.

TABLE 2

| | position | output | | |
|---|---|---|---|---|
| | of | terminal | | |
| | magnetic | H1 | | |
| | pole of | of Hall | Polarity of AC | Rotation direction |
| | rotor | sensor | power supply | of motor |
| first | N | 1 | positive half-cycle | counterclockwise |
| Hall | S | 0 | negative half-cycle | counterclockwise |
| sensor | N | 1 | negative half-cycle | keep rotating under |
| | | | | inertia |
| | S | 0 | positive half-cycle | keep rotating under |
| | | | | inertia |
| second | N | 0 | negative half-cycle | clockwise |
| Hall | S | 1 | positive half-cycle | clockwise |
| sensor | N | 0 | positive half-cycle | keep rotating under |
| | | | | inertia |
| | S | 1 | negative half-cycle | keep rotating under |
| | | | | inertia |

In can be understood that, the switch control circuit 30, the rectifier, and the detection circuit may be integrated or packaged in an integrated circuit, such as an application-specific integrated circuit (ASIC), to reduce cost of the circuit and increase reliability of the circuit.

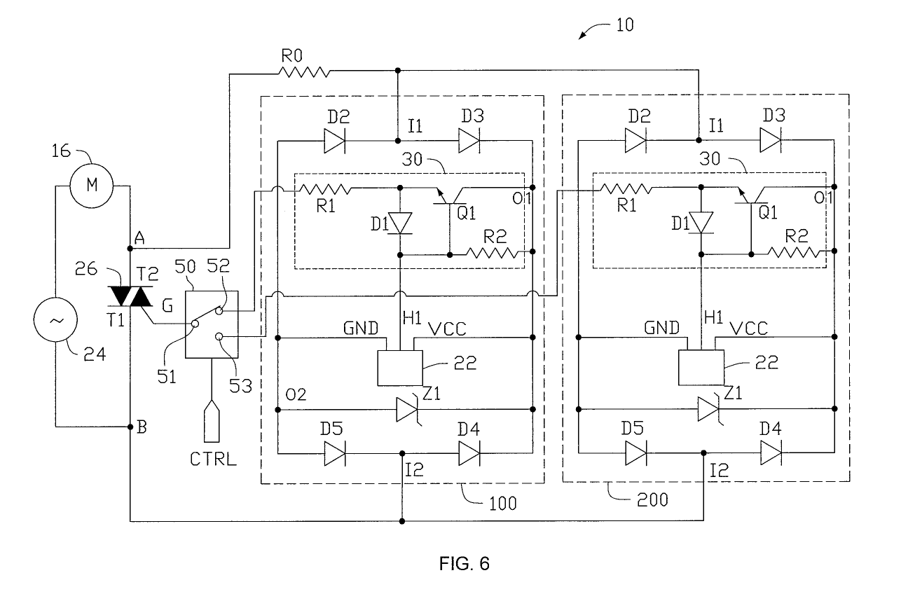

FIG. 6 is a circuit diagram of a motor according to a second embodiment of the present disclosure. The difference between the second embodiment and the first embodiment shown in FIG. 1 is that two motor driving integrated circuits (ICs) are adopted to control the motor to rotate clockwise or counterclockwise, and in each IC the switch control circuit 30, the rectifier and the detection circuit are integrated. The two motor driving integrated circuits are denoted as a first motor driving integrated circuit 100 and a second motor driving integrated circuit 200, respectively. The first motor driving integrated circuit 100 and the second motor driving integrated circuit 200 each includes a housing, the housing includes a front wall and a rear wall, the front wall of the first motor driving integrated circuit 100 faces the rotor 11, and the rear wall of the second motor driving integrated circuit 200 faces the rotor 11. Within each of the first motor drive IC 100 and the second motor drive IC 200, the output terminal H1 of the Hall sensor is directly connected to the second terminal of the corresponding switch control circuit 30, which is different from the embodiment shown in FIG. 1. Structures and operating principles of the switch control circuits, the rectifiers, and the detection circuits in the first motor driving integrated circuit 100 and the second motor driving integrated circuit 200 are the same as those in the first embodiment, which will not be described in detail herein. The rotation direction control circuit 50 is not integrated in the motor driving integrated circuit, and is configured to selectively output a control signal output from the first motor driving integrated circuit 100 or the second motor driving integrated circuit 200 to the controllable bidirectional AC switch 26 based on the rotation direction setting signal of the motor. The controllable bidirectional AC switch 26 is turned on or off to make the motor rotate in a predetermined direction or in a direction opposite to the predetermined direction. In this embodiment, the predetermined direction is counterclockwise, and the direction opposite to the predetermined direction is clockwise.

In the embodiment shown in FIG. 6, the first terminal 51 of the rotation direction control circuit 50 is connected to the control terminal G of the controllable bidirectional AC switch 26, the second terminal 52 of the rotation direction control circuit 50 is connected to the second terminal of the switch control circuit 30 of the first motor driving integrated circuit 100, and the third terminal 53 of the rotation direction control circuit 50 is connected to second terminal of the switch control circuit 30 of the second motor driving integrated circuit 200. The first input terminals I1 of the rectifiers of the first motor driving integrated circuit 100 and the second motor driving integrated circuit 200 are connected to the first node A through the resistor R0, and the second input terminals I2 of the rectifiers of the first motor driving integrated circuit 100 and the second motor driving integrated circuit 200 are connected to the second node B. The first anode T1 of the controllable bidirectional AC switch 26 is connected to the second node B, the second anode T2 is connected to the first node A, and the AC power supply 24 and the stator winding 16 are connected in series between the first node A and the second node B. When the rotation direction setting signal CTRL received by the rotation direction control circuit 50 is at a logic low level, the first terminal 51 is connected to the second terminal 52, and the motor rotates counterclockwise. When the rotation direction setting signal CTRL received by the rotation direction control circuit 50 is at a high logic level, the first terminal 51 of the rotation direction control circuit 50 is connected to the third terminal 53, and the motor rotates clockwise.

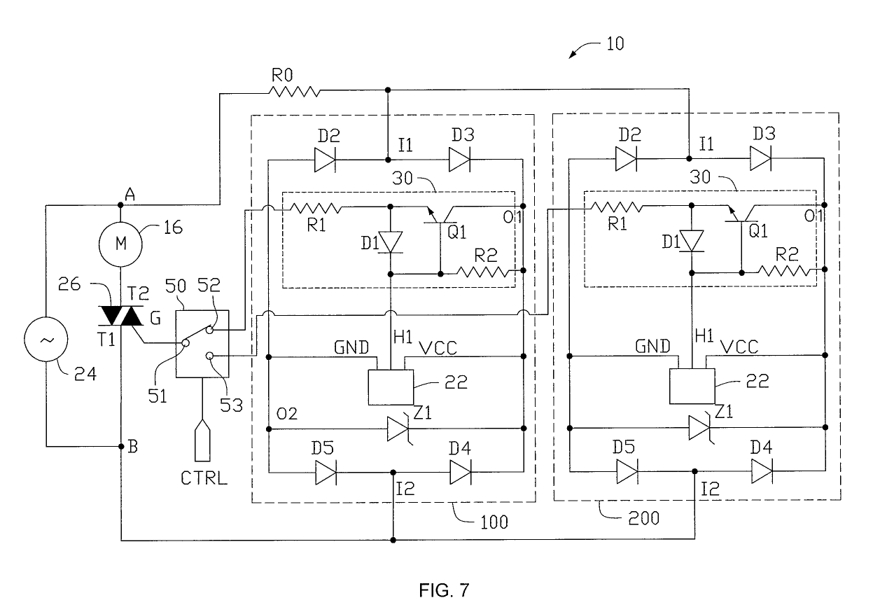

FIG. 7 is a circuit diagram of a motor according to a third embodiment of the present disclosure. The difference between the third embodiment and the second embodiment is that, in the third embodiment, the stator winding 16 and the controllable bidirectional AC switch 26 are connected in series between the first node A and the second node B, and the AC power supply 24 is connected between the first node A and the second node B.

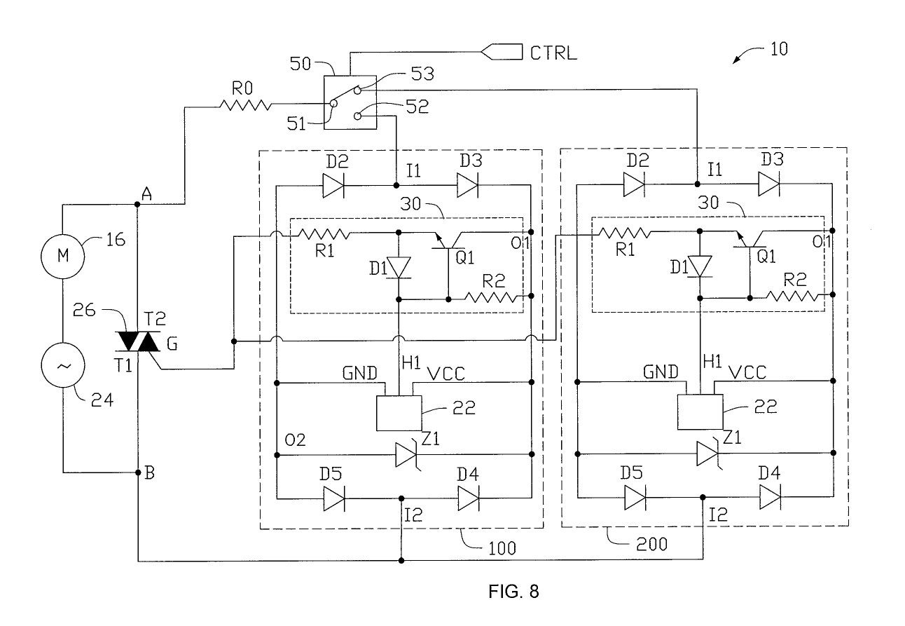

FIG. 8 is a circuit diagram of a motor driving circuit according to a fourth embodiment of the present disclosure. The difference between this embodiment and the embodiment shown in FIG. 6 is that a position of the rotation direction control circuit 50 is changed. In this embodiment, the first terminal 51 of the rotation direction control circuit 50 is connected to the first node A through the resistor R0, the second terminal 52 is connected to the first input terminal I1 of the rectifier of the first motor driving integrated circuit 100, and the third terminal 53 is connected to the first input terminal I1 of the rectifier of the second motor driving integrated circuit 200. The rotation direction control circuit 50 selectively controls the AC power supply 24 to supply power to the first motor driving integrated circuit 100 or the second motor driving integrated circuit 200 based on the rotation direction setting signal CTRL. The control signal from the powered driving integrated circuit is provided to the controllable bidirectional AC switch 26 to control the on or off states of the controllable bidirectional AC switch 26, thereby controlling the motor to rotate clockwise or counterclockwise.

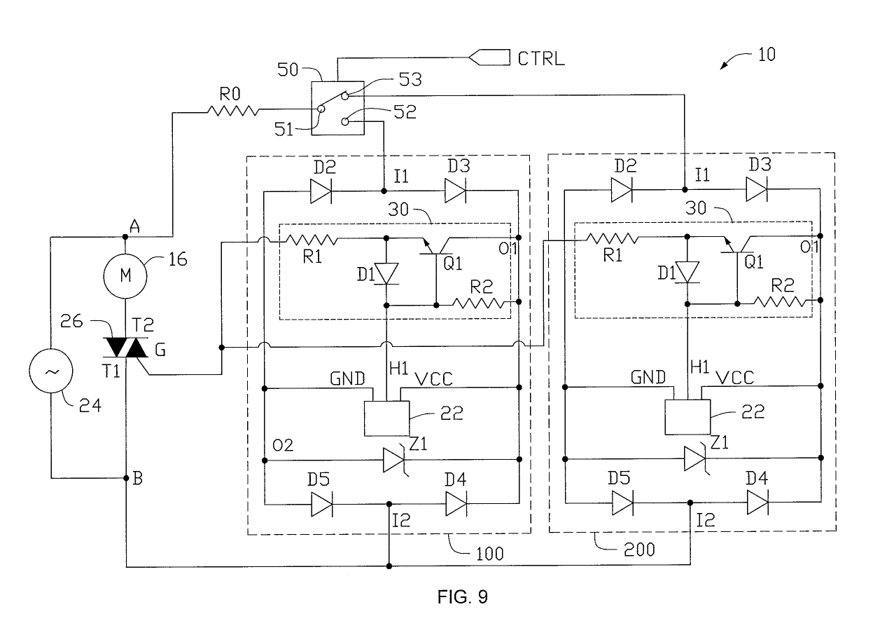

FIG. 9 is a circuit diagram of a motor driving circuit according to a fifth embodiment of the present disclosure. The difference between this embodiment and the embodiment shown in FIG. 8 is that, in this embodiment, the stator winding 16 and the controllable bidirectional AC switch 26 are connected in series between the first node A and the second node B, and the external AC power supply 24 is connected between the first node A and the second node B.

In the above embodiments, the switch unit of the rotation direction control circuit 50 may be a mechanical switch or an electronic switch. The mechanical switch includes a relay, a single-pole double-throw switch, and a single-pole single-throw switch. The electronic switch includes a solid state relay, a metal-oxide semiconductor field effect transistor, a silicon-controlled rectifier, a bidirectional triode thyristor, an insulated gate bipolar transistor, a bipolar junction transistor, a thyristor, and an optocoupler.

It can be understood that, in the embodiments shown in FIGS. 6-9, the switch unit of the rotation direction control circuit 50 may be replaced by the switch unit shown in FIG. 5. When changing the motor rotation direction, the motor is controlled to stop rotating firstly via the rotation direction control circuit 50. It can be understood that other manners may be applied to controlling the motor to stop rotating, for example, a control switch (not shown) is added between the AC power supply 24 and the stator winding 16, and the rotor of the motor may be controlled to stop rotating and rest at a predetermined position by turning off the control switch for a predetermined time.

The motor driving circuit according to the embodiments of the present disclosure detects the positions of the magnetic poles of the rotor 11 through the two detection circuits or the two motor driving integrated circuits. The two detection circuits or the two motor driving integrated circuits output the magnetic pole position signals having the opposite phases when detecting the same magnetic pole of the rotor. According to the rotation direction setting signal of the motor, the rotation direction control circuit 50 selects the magnetic pole position signal or the control signal output from the corresponding detection circuit or the corresponding motor driving integrated circuit, to control the state of the controllable bidirectional AC switch and then control the direction of the current flowing through the stator winding of the motor, so as to control the rotation direction of the motor. The rotation direction of the motor can be changed by only switching the connecting terminals of the rotation direction control circuit 50. The motor driving circuit has a simple structure and a great universality.

In the above embodiments, the rotor 11 is a permanent magnet rotor. Each pole of the permanent magnet rotor can be made of neodymium magnet material extracted from rare earth, or can be made of more durable materials such as rubber-wrapped neodymium magnet (also referred to rubber magnet magnet). The back electromotive force of the motor can be trapezoidal wave. In other embodiments, the permanent magnet rotor may also be made of other materials such as ferrite, neodymium iron boron, alnico, etc. The waveform of the back electromotive force may also be a sine wave or the like.

In the above embodiments, the rectifier is a full bridge rectification circuit. In other implementations, a half bridge rectification circuit, a full-wave rectification circuit, a half-wave rectification circuit, or the like, may be adopted. In this embodiment, the rectified voltage is stabilized through the Zener diode Z1. In other embodiments, the voltage may be stabilized through electronic components such as a three terminal voltage stabilizer.

It can be understood that, the motor described in the embodiments of the present disclosure is suitable for driving devices such as a vehicle window and an office or household roller shutter. The motor according to the embodiments of the present disclosure is an AC motor with permanent magnet rotor, such as synchronous motor and brushless DC electric motor (BLDC motor). The motor according to the embodiments of the present disclosure is preferably a single-phase AC motor with permanent magnet rotor, such as a single-phase synchronous motor and a single-phase BLDC motor. When the motor is a synchronous motor; the AC power source may be commercial AC power supply. When the motor is a BLDC motor, the AC power source may be provided by an inverter.

Although certain inventive embodiments of the present disclosure have been specifically described, the present disclosure is not to be construed as being limited thereto. Various changes or modifications may be made to the present disclosure without departing from the scope and spirit of the present disclosure.

1. A motor driving circuit, for driving a rotor of a motor to rotate with respect to a stator, comprising:
a controllable bidirectional alternating current (AC) switch, connected with a winding of the motor between two terminals of an AC power supply;
a first detection circuit and a second detection circuit, respectively configured to detect positions of magnetic poles of the rotor, and output magnetic pole position signals having opposite phases when detecting a same magnetic pole of the rotor;
a rotation direction control circuit connected to the first and second detection circuits, and configured to selectively output the magnetic pole position signals from the first detection circuit or the second detection circuit to a switch control circuit according to a rotation direction setting signal of the motor;
wherein the switch control circuit is configured to control the controllable bidirectional AC switch to be switched between a switch-on state and a switch-off state to control the motor to rotate in a predetermined direction or in a direction opposite to the predetermined direction, based on the received magnetic pole position signal and a polarity of the AC power supply.

2. The motor driving circuit of claim 1, wherein the switch control circuit is configured to control the controllable bidirectional AC switch to be switched to the switch-on state when the polarity of the AC power supply is in a positive half-cycle and the rotation direction control circuit outputs a first signal, or the switch control circuit is configured to control the controllable bidirectional AC switch to be switched to the switch-on state when the polarity of the AC power supply is in a negative half-cycle and the rotation direction control circuit outputs a second signal.

3. The motor driving circuit of claim 1, wherein the rotation direction control circuit outputs the magnetic pole position signal from the first detection circuit to the switch control circuit when the motor rotates in the predetermined direction; and the rotation direction control circuit outputs the magnetic pole position signal from the second detection circuit to the switch control circuit when the motor rotates in the direction opposite to the predetermined direction.

4. The motor driving circuit of claim 1, wherein the first detection circuit comprises a first Hall sensor, the second detection circuit comprises a second Hall sensor, and a direction in which a first Hall plate in the first Hall sensor faces the rotor is inverted by 180 degrees with respect to the direction in which a second Hall plate in the second Hall sensor faces the rotor.

5. The motor driving circuit of claim 4, wherein at a rest position of the motor, the first Hall sensor and the second Hall sensor are both disposed adjacent to a north pole of the rotor, or the first Hall sensor is adjacent to a north pole of the rotor and the second Hall sensor is adjacent to a south pole of the rotor.

6. The motor driving circuit of claim 1, wherein the rotation direction control circuit comprises a switch unit, the switch unit comprises first to third terminals, the first terminal is connected to the switch control circuit, the second terminal receives the magnetic pole position signal from the first detection circuit, the third terminal receives the magnetic pole position signal from the second detection circuit, and the first terminal is selectively connected to the second terminal or the third terminal according to the rotation direction setting signal of the motor; when the first terminal is connected to the second terminal, the motor rotates in the predetermined direction; and when the first terminal is connected to the third terminal, the motor rotates in the direction opposite to the predetermined direction.

7. The motor driving circuit of claim 6, wherein the switch unit of the rotation direction control circuit further comprises a fourth terminal, the fourth terminal is null, when switching the rotation direction of the motor during rotation, the first terminal is connected to the fourth terminal for a preset time to stop the rotor at a predetermined rest position, then the first terminal is connected to the terminal corresponding to the switching direction.

8. The motor driving circuit of claim 4, wherein the motor driving circuit further comprises a rectifier for providing a DC voltage to at least the first and the second Hall sensors, the rectifier comprises first and second output terminals, a voltage output from the first output terminal is higher than that from the second output terminal, power supply terminals of the first and second Hall sensors are connected to the first output terminal, and ground terminals of the first and second Hall sensors are connected to the second output terminal.

9. The motor driving circuit of claim 8, wherein the motor driving circuit 19 further comprises a voltage reducer connected to the rectifier, for stepping down an AC voltage from the AC power supply and then inputting the reduced voltage to the rectifier, the switch control circuit comprises a first resistor, an NPN transistor, a second resistor, and a diode; the second resistor and diode are connected in series between the rotation direction control circuit and the controllable bidirectional AC switch; a cathode of the diode is connected to the rotation direction control circuit; an end of the first resistor is connected to a first output terminal of the rectifier, and the other end of the first resistor is connected to the cathode of the diode; a base of the NPN transistor is connected to the cathode of the diode, an emitter of the NPN transistor is connected to an anode of the diode, and a collector of the NPN transistor is connected to the first output terminal of the rectifier.

10. The motor driving circuit of claim 1, wherein the motor driving circuit further comprises a control switch, the control switch is connected between the AC power supply and the winding of the motor, when changing the rotation direction the during the rotation of the motor, the control switch is turned off for a predetermined time until the rotor stops at a predetermined rest position.

11. A motor driving circuit, for rotating a rotor of a motor with respect to a stator, the motor driving circuit comprising:
a controllable bidirectional AC switch, connected between a first node and a second node, a motor winding and an AC power supply connected in series between the first node and the second node, or the controllable bidirectional AC switch and the motor winding connected in series between the first node and the second node, and the AC power supply connected between the first node and the second node;
first and second motor driving integrated circuits having the same structure, each of which including a housing, the housing including a front wall and a rear wall, the front wall of the first motor driving integrated circuit facing the rotor, the rear wall of the second motor driving integrated circuit facing the rotor, each of the first and second motor driving integrated circuits comprising:
a detection circuit, configured for detecting a magnetic pole position of the rotor and outputting a magnetic pole position signal at an output thereof;
a switch control circuit, configured to output a control signal according to the magnetic pole position signal from the detection circuit and a polarity of the AC power supply;
a rotation direction control circuit, configured to selectively output the control signal from the first or second motor drive integrated circuits to the controllable bidirectional AC switch according to the rotation direction setting signal of the motor to control on and off states of the controllable bidirectional AC switch to rotate the motor in a predetermined direction or in a direction opposite to the predetermined direction.

12. A motor 10 comprising a stator, a rotor and a motor driving circuit, the motor driving circuit comprising:
a controllable bidirectional alternating current (AC) switch, connected with a winding of the motor between two terminals of an AC power supply;
a first detection circuit and a second detection circuit, respectively configured to detect positions of magnetic poles of the rotor, and output magnetic pole position signals having opposite phases when detecting a same magnetic pole of the rotor;
a rotation direction control circuit connected to the first and second detection circuits, and configured to selectively output the magnetic pole position signals from the first detection circuit or the second detection circuit to a switch control circuit according to a rotation direction setting signal of the motor;
wherein the switch control circuit is configured to control the controllable bidirectional AC switch to be switched between a switch-on state and a switch-off state to control the motor to rotate in a predetermined direction or in a direction opposite to the predetermined direction, based on the received magnetic pole position signal and a polarity of the AC power supply.

13. The motor of claim 12, wherein the motor is a single-phase permanent magnet AC motor, a single-phase permanent magnet synchronous motor, or a single-phase permanent magnet BLDC motor.
